(19) United States
(12) Patent Application Publication
(10) Pub. No.: US 2024/0053650 A1
(43) Pub. Date: Feb. 15, 2024

(54) EDGE PORT CELL-SPACE REDUCTION USING A SEAL-EMBEDDED SLIDE

(71) Applicant: Gentex Corporation, Zeeland, MI (US)

(72) Inventors: Michael J. Dornbush, Holland, MI (US); Gerald W. Redwine, Holland, MI (US); Garret C. DeNolf, Grand Rapids, MI (US); Stephen F. Richlich, Holland, MI (US); Kevin L. Ash, Grand Rapids, MI (US); Donald L. Bareman, Zeeland, MI (US); David R. Bush, Grand Haven, MI (US)

(73) Assignee: Gentex Corporation, Zeeland, MI (US)

(21) Appl. No.: 18/233,389

(22) Filed: Aug. 14, 2023

Related U.S. Application Data
(60) Provisional application No. 63/398,018, filed on Aug. 15, 2022.

(51) Int. Cl. G02F 1/161; G02F 1/1333

(52) U.S. Cl. CPC G02F 1/161; G02F 1/133354

(57) ABSTRACT

An electro-optic assembly includes a first substrate that has a first surface and a second surface that is opposite the first surface. A second substrate has a third surface and a fourth surface that is opposite the third surface. The first and second substrates are disposed in a parallel and spaced apart relationship so as to define a cavity therebetween. The second and third surfaces face each other. A seal extends between the first and second substrates. An electro-optic medium is located in the cavity and is retained by the seal. A port is at least partially defined by a port reduction member that is located between the first substrate and the second substrate.

### CROSS-REFERENCE TO RELATED APPLICATION

This application claims priority to and the benefit under 35 U.S.C. § 119(e) of U.S. Provisional Application No. 63/398,018, filed on Aug. 15, 2022, entitled “EDGE PORT CELL-SPACE REDUCTION USING A SEAL-EMBEDDED SLIDE,” the disclosure of which is hereby incorporated herein by reference in its entirety.

### FIELD OF THE DISCLOSURE

The present disclosure generally relates to an electro-optic assembly, and, more particularly, to an electro-optic assembly with a port reduction member.

### SUMMARY OF THE DISCLOSURE

According to one aspect of the present disclosure, an electro-optic assembly includes a first substrate that has a first surface and a second surface that is opposite the first surface. A second substrate has a third surface and a fourth surface that is opposite the third surface. The first and second substrates are disposed in a parallel and spaced apart relationship so as to define a cavity therebetween. The second and third surfaces face each other. A seal extends between the first and second substrates. An electro-optic medium is located in the cavity and is retained by the seal. A port is at least partially defined by a port reduction member that is located between the first substrate and the second substrate.

According to another aspect of the present disclosure, an electro-optic assembly includes a first substrate that has a first surface and a second surface that is opposite the first surface. A second substrate has a third surface and a fourth surface that is opposite the third surface. The first and second substrates are disposed in a parallel and spaced apart relationship so as to define a cavity therebetween. The second and third surfaces face each other. A seal extends between the first and second substrates. An electro-optic medium is located in the cavity and is retained by the seal. A port is defined by the seal, the first substrate, and the second substrate. A port reduction member located within the port that reduces a size of the port.

According to another aspect of the present disclosure, a method of assembling an electro-optic assembly includes a step where a first substrate is aligned over a second substrate to define a cavity therebetween. A seal is placed between the first substrate and the second substrate to define a transmission perimeter. A port reduction member is coupled to at least one of the substrates and at least partially defines a port.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a top elevational view of an automobile that incorporates an electro-optic assembly of the present disclosure;

FIG. 1B is a side perspective view of an airplane that incorporates an electro-optic assembly of the present disclosure;

FIG. 1C is a side elevational view of a rail vehicle that incorporates an electro-optic assembly of the present disclosure;

FIG. 1D is a front elevational view of a building, such as a home, that incorporates an electro-optic assembly of the present disclosure;

FIG. 2 is a cross-sectional view of an electro-optic assembly of a first construction, in accordance with an aspect of the present disclosure;

FIG. 3 is a cross-sectional view of an electro-optic assembly of a second construction, in accordance with an aspect of the present disclosure;

FIG. 4 is a cross-sectional view of an electro-optic assembly of a third construction, in accordance with an aspect of the present disclosure;

FIG. 5 is a cross-sectional view of an electro-optic assembly of a fourth construction, in accordance with an aspect of the present disclosure; and

FIG. 6 is a flow chart that illustrates a method of assembling an electro-optic assembly of the present disclosure.

### DETAILED DESCRIPTION

The present illustrated embodiments reside primarily in combinations of method steps and apparatus components related to an electro-optic assembly with a port reduction member. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

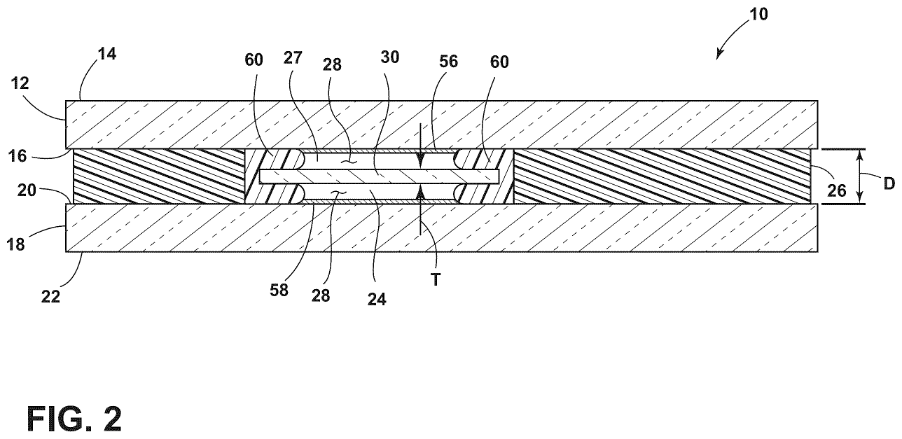

For purposes of description herein, the terms “upper,” “lower,” “right,” “left,” “rear,” “front,” “vertical,” “horizontal,” and derivatives thereof, shall relate to the disclosure as oriented in FIG. 2. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

With initial reference to FIG. 2, the present disclosure is generally related to an electro-optic assembly 10 that can be implemented in numerous applications with a variety of constructions. The electro-optic assembly 10 is shown in a first construction and includes a first substrate 12 that has a first surface 14 and a second surface 16 that is opposite the first surface 14. A second substrate 18 has a third surface 20 and a fourth surface 22 that is opposite the third surface 20. The second and third surfaces 16, 20 face each other. The first and second substrates 12, 18 are disposed in a parallel and spaced apart relationship so as to define a cavity 24 therebetween. The second and third surfaces 16, 20 face each other. A seal 26 extends between the first and second substrates 12, 18. An electro-optic medium 27 is located in the cavity 24 and is retained by the seal 26. A port 28 is at least partially defined by a port reduction member 30 that is located between the first substrate 12 and the second substrate 18 that can be plugged with a plug material.

The electro-optic medium 27 can be actuated to vary a degree of transmission of light through a transmission area. The transmission of light may be actuated between a clear state and a darkened state. In the darkened state, the transmission area may be opaque (e.g., with a window application) or reflective (e.g., with a dimming mirror application). The port reduction member 30 at least partially defines the port 28 such that at least a portion of the port 28 may be smaller than a distance “D” between the first and second substrates 12, 18. As such, after the cavity 24 is filled with the electro-optic medium 27, closing the port 28 is simplified and a reliable operational life is maintained. Such configurations are particularly beneficial in applications where the distance “D” between the first and second substrates 12, 18 is large enough to make reliably closing the port 28 difficult, for example, as a result of shrinkage of a plugging material during a curing process.

With continued reference to FIG. 2, an unreliable plugging of the port 28 can result in degradation of the electro-optic medium 27 via oxygenation, moisture, and other environmental factors. Moreover, shrinkage of the plug material can also result in non-uniform cell spacing throughout the electro-optic assembly 10. It should be appreciated that the port reduction member 30 may alternatively be described as reducing the size of the port 28. Therefore, it is contemplated that the port reduction member 30 may be located in alternative positions reduce not only in the distance D direction illustrated in the figures but also direction transverse to the distance D (e.g., perpendicular). Generally speaking, the port reduction member 30 facilitates a durable moisture and oxygen barrier in the port 28. The thermally cured seal 26 produces an oxygen and moisture barrier. However, the plug material inserted into the port 28 may be UV cured, which is difficult when the plug material is too thick. By a reduction in size of the port 28 via the port reduction member 30, the quantity of required plug material is minimize, increasing the ability to cure the center of plug material. In addition, when cured, the plug material experiences shrinkage that is minimized by the reduction in size. In other words, a larger required quantity of plug material is a less effective barrier and becomes unreliable as it gets thicker. The port reduction member 30 is made of a material that is not moisture or oxygen permeable (e.g., glass). The port reduction member 30 is added to reduce the cross-sectional thickness of the plug material and thus improve the plugs barrier performance (e.g., limit oxygen and moisture permeability to the electro-optic medium 27).

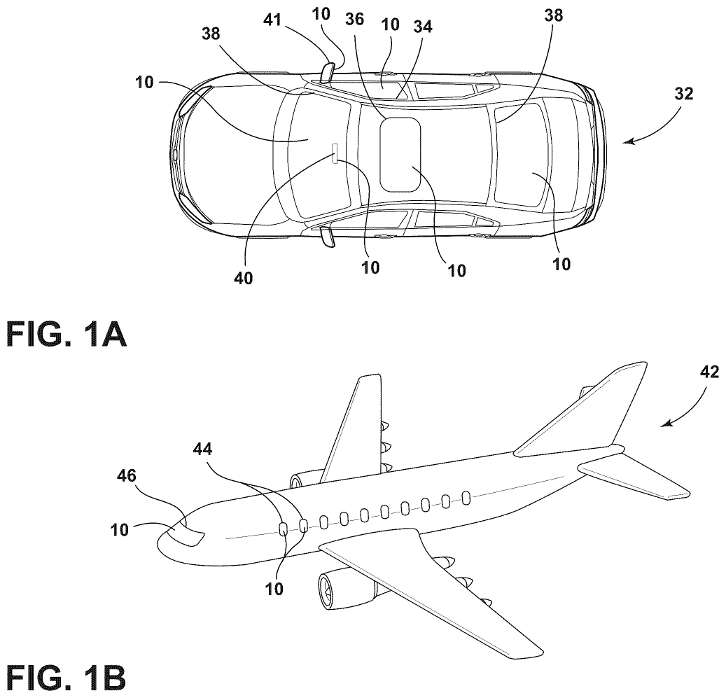

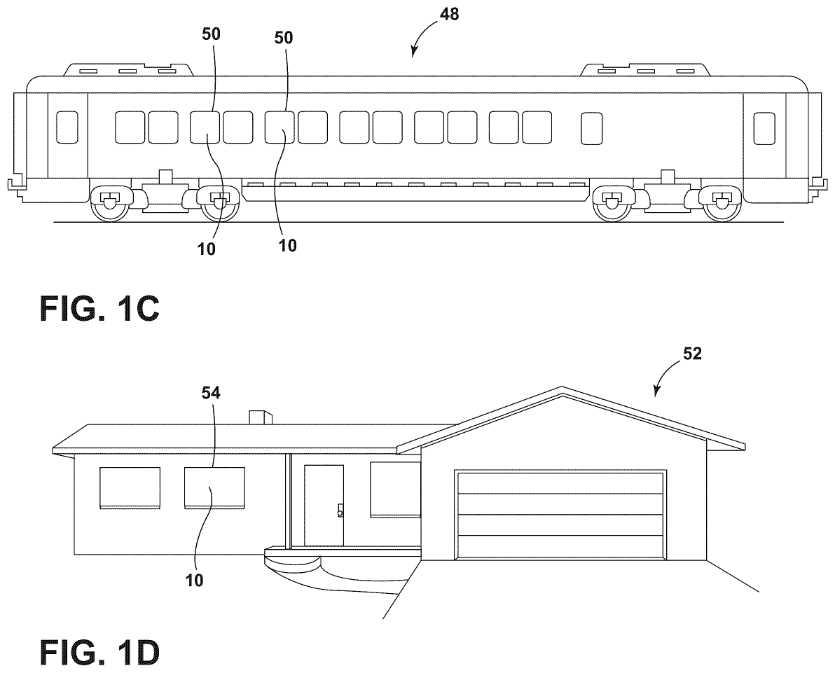

Referring now to FIGS. 1A-1D, the electro-optic assembly 10 is configured to be actuated between the clear state and the darkened state. Various constructions of electro-optic assembly 10 may be incorporated with one or more structures. For example, FIG. 1A illustrates an automobile 32 that employs the electro-optic assembly 10, for example, on a sunroof frame 34, an automobile side window frame 36, and/or an automobile front or rear window frame 38. In some embodiments, the electro-optic assembly 10 may be configured as a dimmable mirror and components of the electro-optic assembly 10 may be located within a rearview mirror frame 40 or a side view mirror frame 41. The automobile 32 may include a commercial vehicle, a bus, an emergency vehicle, a residential vehicle, or the like. FIG. 1B illustrates an airplane 42 that employs the electro-optic assembly 10. For example, the electro-optic assembly 10 may be located in airplane side windows 44 or airplane front windows 46. FIG. 1C illustrates a railed vehicle 48, such as a train, a subway, a trolley, and or the like. The electro-optic assembly 10 may be located in a train window frame 50. FIG. 1D illustrates a building 52 that employs the electro-optic assembly 10. The building 52 may be a residential building, a commercial building, a medical facility, and/or the like. The electro-optic assembly 10 may be located in a building window frame 54. Generally speaking, the electro-optic assembly 10 may be incorporated into any environment where changes in transmission levels (e.g., via varying opaqueness or reflectivity) are beneficial.

With reference again to FIG. 2, the electro-optic medium 27 at least partially fills the cavity 24 and is configured to change light transmissivity (i.e., by increasing opaqueness or reflectivity). In some embodiments, the electro-optic medium 27 may be a solution-phase, electrochromic medium. A first electrode layer 56 may be disposed on the second surface 16 of the first substrate 12, and a second electrode layer 58 may be disposed on the third surface 20 of the second substrate 18. In other words, the first electrode layer 56 and the second electrode layer 58 may be located on internal surfaces of the first and second substrates 12, 18 to at least partially delimit the cavity 24 and interface with the electro-optic medium 27. The first electrode layer 56 and the second electrode layer 58 may be formed by electrically conductive transparent materials, including, but not limited to, a transparent metal oxide (e.g., indium tin oxide, F:SnO2, ZnO, IZO), insulator-metal-insulator (“IMI”) structures, carbon (graphene and/or graphite), and/or a conductive metal mesh (e.g., nanowires). The first electrode layer 56 and the second electrode layer 58 may be located in an inbound direction from the seal 26.

In various examples, the electro-optic medium 27 may include at least one solvent, at least one anodic material, and at least one cathodic material. Typically, both of the anodic and cathodic materials are electroactive, and at least one of them may be electrochromic. It will be understood that regardless of its ordinary definition, the term “electroactive” may include a material that undergoes a modification in its oxidation state upon exposure to a particular electrical potential difference. Additionally, it will be understood that the term “electrochromic” may include, regardless of its ordinary definition, a material that exhibits a change in its extinction coefficient at one or more wavelengths upon exposure to a particular electrical potential difference.

With continued reference to FIG. 2, the seal 26 extends around an outer perimeter of the electro-optic medium 27 to define a transmission area that is substantially visible to an observer. The seal 26 may be formed of an epoxy material and the epoxy material may include spacer elements such as spherical or semi-spherical beads, pads, rods, or fibers. The port 28 extends through the seal 26 to inject the electro-optic medium 27 during assembly. The port reduction member 30 at least partially defines the port 28 such that at least a portion of the port 28 is smaller than the distance “D” between the first substrate 12 and the second substrate 18. The port reduction member 30 may be formed of a glass material that is suspended between the second surface 16 and the third surface 20. More particularly, the port reduction member 30 is held in place (e.g., statically) by a pair of holding members 60 that are spaced from one another. The holding members 60 may formed of an epoxy material without spacer elements. In some embodiments, the holding members 60 are cured prior to the introduction of the seal 26. The port reduction member 30 may be parallel with the first substrate 12 and/or the second substrate 18 or otherwise oriented. The holding members 60 may be located on opposite edges of the port reduction member 30. Each holding member 60 may extend between the port reduction member 30 and the second surface 16 and between the port reduction member 30 and the third surface 20. As such, the port 28 may be substantially equally split by the port reduction member 30 (e.g., equally or unequally). In some embodiments, the port reduction member 30 is located centrally in a distance between the second and third surface 16, 20. The glass material may be formed of various types of glass (soda lime, borosilicate, boroaluminosilicate, Carrara, and/or the like). In some embodiments, the glass material is similar to the composition of the first and second substrates 12, 18 and provides a similar thermal expansion coefficient. The port reduction member 30 may include one or more stacked port reduction members 30. Likewise, the port 28 may include two or more ports 28 with each port 28 at least partially defined by the one or more port reduction members 30.

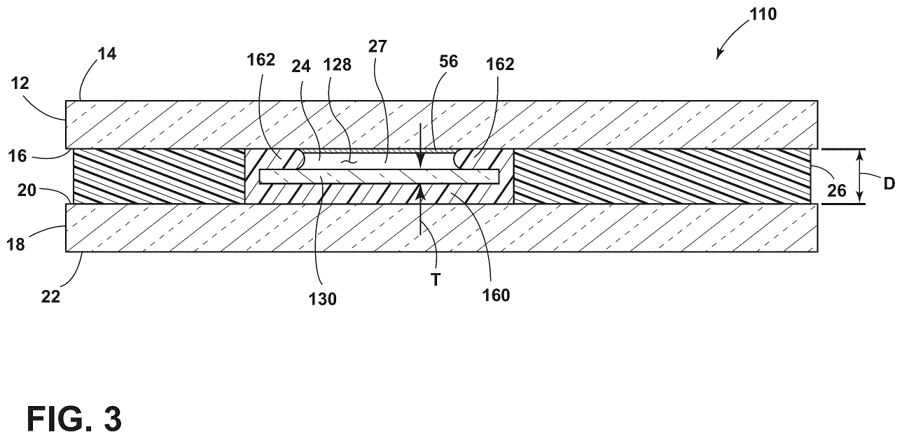

With reference now to FIG. 3, an electro-optic assembly 110 in accordance with a second construction is illustrated. Unless otherwise specified, the electro-optic assembly 110 may be incorporated into at least the structures in FIGS. 1A-1D and include similar features, elements, and materials as the other constructions set forth herein and illustrated in FIGS. 2, 4, and 5. However, the connection of a port reduction member 130 has been modified. More particularly, the port reduction member 130 is suspended between the second surface 16 and the third surface 20 by a singular holding member 160. The holding member 160 includes opposite ends 162 and wraps around one side of the port reduction member 130 such that the opposite ends 162 are located on an opposite side of the port reduction member 130. The opposite ends 162 are spaced from one another on the opposite side of the port reduction member 130 to form a port 128. Therefore, the port 128 is a singular opening. The holding member 160 may be formed of an epoxy material, and the epoxy material may not include spacer elements. In some embodiments, the holding members 160 are cured prior to the introduction of the seal 26. The port reduction member 130 may include one or more stacked port reduction members 130. Likewise, the port 128 may include two or more ports 128 with each port 128 at least partially defined by the one or more port reduction members 130.

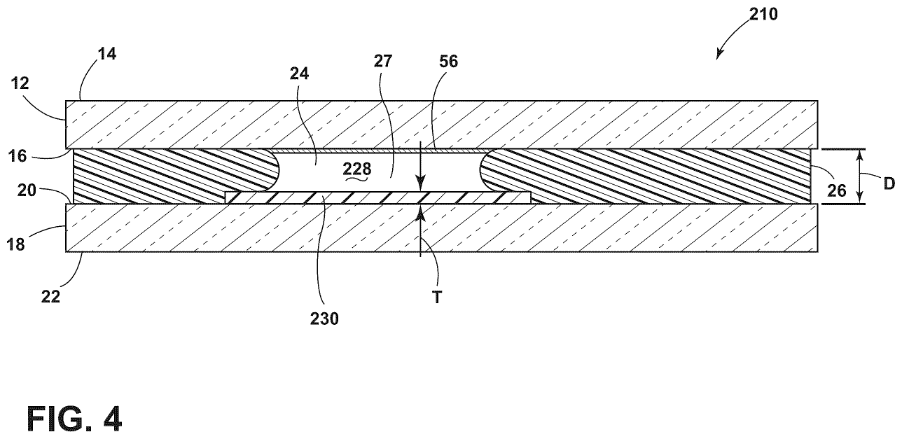

With reference now to FIG. 4, an electro-optic assembly 210 in accordance with a third construction is illustrated. Unless otherwise specified, the electro-optic assembly 210 may be incorporated into at least the structures in FIGS. 1A-1D and include similar features, elements, and materials as the other constructions set forth herein and illustrated in FIGS. 2, 3, and 5. However, the electro-optic assembly 210 includes a port reduction member 230 that is modified. More particularly, the port reduction member 230 may be directly adhered to one of the first and second substrates 12, 18 to define a port 228. The port reduction member 230 may include one or more port reduction members 230 that define the port 228 (e.g., a pair of port reduction members 230 directly adhered to each of the first and second substrates 12, 18). The port 228 may include two or more ports 228 with each port 228 at least partially defined by the one or more port reduction members 230. The port reduction member 230 may be formed of epoxy that may or may not have spacer elements. The seal 26 may extend at least partially between the port reduction member 230 and the first or second substrates 12, 18 that the port reduction member 230 is not adhered to. In some embodiments, the port reduction member 230 may be formed of glass and at least partially adhered to the first or second substrate 12, 18 via an etching, abrasions, and/or adhesives. In some embodiments, the port reduction member 230 may be formed integrally with the first or second substrate 12, 18. In some embodiments, the port reduction member 230 may include a pair of port reduction members 230 each located on one or each of the first or second substrates 12, 18.

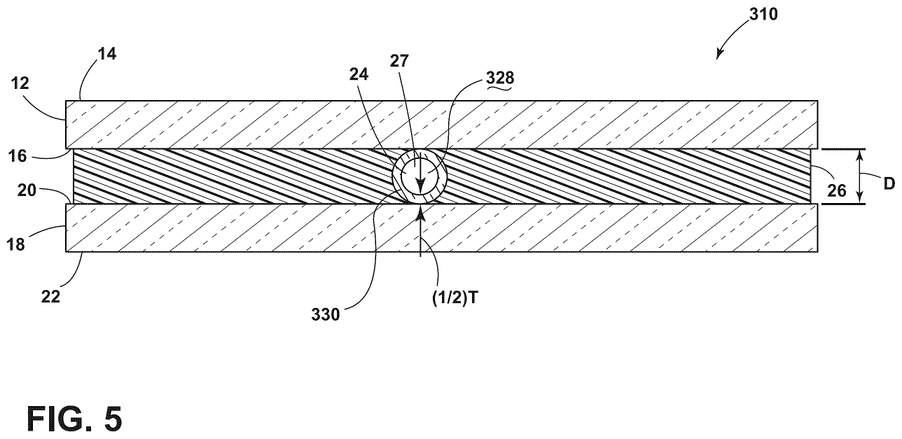

With reference now to FIG. 5, an electro-optic assembly 310 in accordance with a fourth construction is illustrated. Unless otherwise specified, the electro-optic assembly 310 may be incorporated into at least the structures in FIGS. 1A-1D and include similar features, elements, and materials as the other constructions set forth herein and illustrated in FIGS. 2-4. However, the electro-optic assembly 310 includes a port reduction member 330 that is modified. More particularly, the port reduction member 330 may be configured as (e.g., defined by) one or more semi-tubular inserts. The one or more port reduction members 330 defines a port 328 that extends therethrough. The port 328 may include two or more ports 328 with each port 328 at least partially defined by the one or more port reduction members 330. The semi-tubular insert may have a circular cross-section, a rectangular cross-section, or any other shape that defines the port 328, either partially or completely. In some embodiments, the port reduction member 330 may be formed of a glass material, as described above, a Teflon® material, a metal material (e.g., stainless steel), and/or the like. The port reduction member 330 may be connected to the first substrate 12 and/or the second substrate 18 via holding members 60, as described above, adhesive, the seal 26, and/or the like.

With reference now to FIGS. 2-5, for each of the illustrated constructions, once the electro-optic medium 27 has been located in the cavity 24, the ports 28, 128, 228, 328 are closed off (e.g., hermitically sealed) to retain the electro-optic medium 27. In some embodiments, the ports 28, 128, 228, 328 may include at least one (e.g., a pair, or more) port 28, 128, 228, 328, such that one of the ports 28, 128, 228, 328 is filled and another port 28, 128, 228, 328 in the same electro-optic assembly 10, 110, 210, 310 permits air to escape during the filling process. In embodiments with multiple ports 28, 128, 228, 328, a port reduction member 30, 130, 230, 330 may be located in each of the ports 28, 128, 228, 328 in the same electro-optic assembly 10, 110, 210, 310. The ports 28, 128, 228, 328 may be plugged via a valve. The valve may be configured to be closed externally or internally (e.g., a rubber gate valve) from the electro-optic assembly 10, 110, 210, 310. In other embodiments, the ports 28, 128, 228, 328 may be plugged via a thumb-tack valve, a glue, an epoxy plug (pre- or post-curing), one or more plug members, and other types of mediums that can be injected and/or cured therein. In some embodiments, the port 328 may be closed via deforming the port reduction member 330 (e.g., by twisting and/or folding). The distance “D” between the first substrate 12 and the second substrate 18 may be 250 μm or greater, for example, 300 μm or greater, 350 μm or greater, 400 μm or greater, 450 μm or greater, 500 μm or greater, 1 mm or greater, 1 mm or less, between 300 μm and 500 μm, between 350 μm and 450 μm, or about 400 μm. In the direction of the distance “D” between the first substrate 12 and the second substrate 18 or, alternatively, along at least one side of the port reduction members 30, 130, 230, 330, the ports 28, 128, 228, 328 may have a cross-sectional measurement that is less than the distance “D.” For example, the cross-sectional measurement (e.g., a vertical measurement substantially along an entire width or a horizontal measurement substantially along an entire height) may be 300 μm or less, 250 μm or less, 200 μm or less, 150 μm or less, between 200 μm and 300 μm, between 200 μm and 250 μm, or about 220 μm or less. Other cross-sectional measurements may be greater, so long as the ports 28, 128, 228, 328 along one direction maintains one of the ranges of measurements described above to reliably limit shrinkage. In some embodiments, the port reduction members 30, 130, 230, 330 may have a thickness “T” that is 50 μm or greater, 100 μm or greater, 150 μm or greater, 200 μm or greater, 250 μm or greater, between 100 μm and 200 μm, or about 150 μm.

The constructions shown in the drawings are depicted with generally flat first and second substrates 12, 18. However, it is understood that the disclosure is not limited to flat substrates. The first and second substrates 12, 18 may be flat, bent, curved, or combinations of these shapes without deviating from the spirit of the present disclosure. In some embodiments, the first and second substrates 12, 18 are substantially transparent.

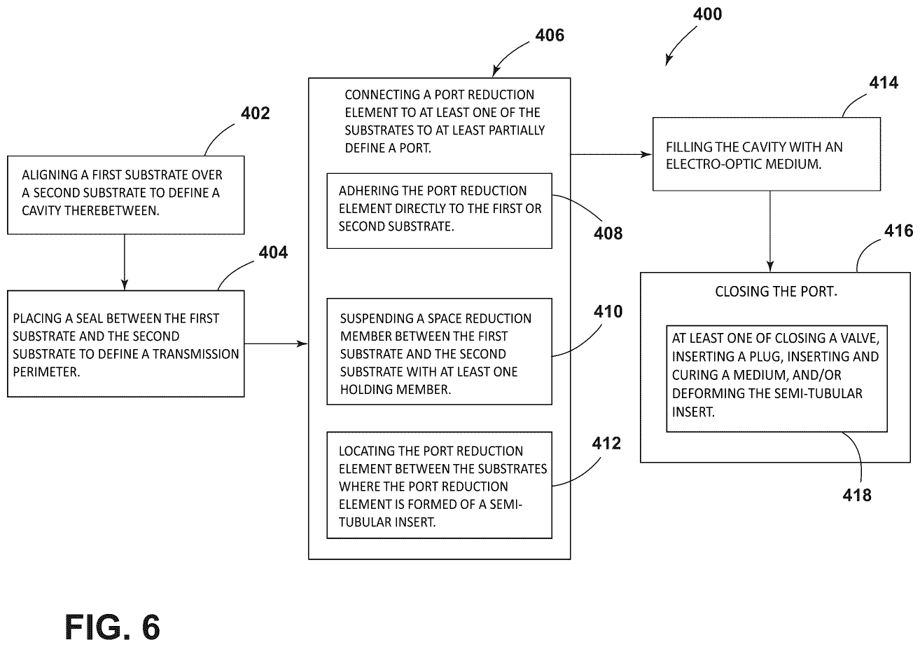

With reference now to FIG. 6, a method 400 of assembling an electro-optic assembly 10, 110, 210, 310 is illustrated. The method 400 includes a step 402 where a first substrate is aligned over a second substrate to define a cavity therebetween. At step 404, a seal is placed between the first substrate and the second substrate to define a transmission perimeter. In some embodiments, step 404 may occur before step 402. At step 406, a port reduction member is connected to at least one of the substrates to at least partially define a port. In some embodiments, step 406 may occur before steps 402 or 404. Step 406 may include, a step 408, where the port reduction member is adhered directly to the first or second substrate. In step 408, the port reduction member may be formed of an epoxy material. Step 406 may, alternatively, include, a step 410 where a port reduction member is suspended between the first substrate and the second substrate with at least one holding member. Step 410 may include using a pair of holding members to split the port or, alternatively, using a single holding member that wraps around a side of the port reduction member to opposite ends of the holding member and defines a singular port. In step 410, the port reduction member may be formed of a glass material and the at least one holding member may be formed of an epoxy material (e.g., without spacer elements). Step 406 may, alternatively, include a step 412 where the port reduction member is located between the first and second substrates where the port reduction member is formed of a semi-tubular insert with the port at least partially defined therein. At step 414, the cavity is filled with an electro-optic medium. At step 416, the port is closed. Step 416, may include a step 418, where at least one of closing a valve, inserting a plug, inserting and curing a medium, and/or deforming the semi-tubular insert occurs.

The invention disclosed herein is further summarized in the following paragraphs and is further characterized by combinations of any and all of the various aspects described therein.

According to one aspect of the present disclosure, an electro-optic assembly includes a first substrate that has a first surface and a second surface that is opposite the first surface. A second substrate has a third surface and a fourth surface that is opposite the third surface. The first and second substrates are disposed in a parallel and spaced apart relationship so as to define a cavity therebetween. The second and third surfaces face each other. A seal extends between the first and second substrates. An electro-optic medium is located in the cavity and is retained by the seal. A port is at least partially defined by a port reduction member located between the first substrate and the second substrate.

According to one aspect, a port is closed with at least one of a valve, a plug, a cured medium, or a deformation of a port reduction member.

According to another aspect, a port reduction member is suspended between a first substrate and a second substrate with at least one holding member.

According to yet another aspect, at least one holding member includes a pair of holding members spaced from one another.

According to still another aspect, a port is split by a port reduction member.

According to another aspect, at least one holding member includes a singular holding member that wraps around one side of a port reduction member to opposite ends of the holding member that are located on an opposite side of the port reduction member.

According to yet another aspect, a port reduction member is directly adhered to one of a first substrate and a second substrate.

According to yet another aspect, a port reduction member includes a semi-tubular insert that defines a port.

According to another aspect of the present disclosure, an electro-optic assembly includes a first substrate that has a first surface and a second surface that is opposite the first surface. A second substrate has a third surface and a fourth surface that is opposite the third surface. The first and second substrates are disposed in a parallel and spaced apart relationship so as to define a cavity therebetween. The second and third surfaces face each other. A seal extends between the first and second substrates. An electro-optic medium is located in the cavity and is retained by the seal. A port is defined by the seal, the first substrate, and the second substrate. A port reduction member located within the port that reduces a size of the port.

According to another aspect, a size of a port is at least partially defined by a distance between a second and a third surface.

According to yet another aspect, a port reduction member is located between and spaced from a second and a third surface.

According to still yet another aspect, a port reduction member is located centrally in a distance between a second and a third surface.

According to another aspect, at least one holding member statically retains a port reduction member.

According to yet another aspect, at least one holding member includes a pair of holding members spaced from one another.

According to still yet another aspect, at least one holding member is formed of epoxy.

According to yet another aspect, a port reduction member is formed of glass.

According to still yet another aspect, a port reduction member is directly adhered to one of a first substrate and a second substrate.

According to another aspect of the present disclosure, a method of assembling an electro-optic assembly includes a step where a first substrate is aligned over a second substrate to define a cavity therebetween. A seal is placed between the first substrate and the second substrate to define a transmission perimeter. A port reduction member is coupled to at least one of the first and second substrates and at least partially defines a port.

According to yet another aspect of the present disclosure, a method of assembling an electro-optic assembly includes a step where a port reduction member is adhered directly to at least one of a first substrate or a second substrate.

According to still another aspect of the present disclosure, a method of assembling an electro-optic assembly includes a step where a port is closed with at least one of closing a valve, inserting a plug, inserting and curing a medium, or deforming a port reduction member.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An electro-optic assembly comprising:
a first substrate having a first surface and a second surface opposite the first surface;
a second substrate having a third surface and a fourth surface opposite the third surface, the first and second substrates disposed in a parallel and spaced apart relationship so as to define a cavity therebetween, the second and third surfaces facing each other;
a seal extending between the first and second substrates, an electro-optic medium located in the cavity and retained by the seal; and
a port at least partially defined by a port reduction member located between the first substrate and the second substrate.

2. The electro-optic assembly of claim 1, wherein the port is closed with at least one of a valve, a plug, a cured medium, or a deformation of the port reduction member.

3. The electro-optic assembly of claim 1, wherein the port reduction member is suspended between the first substrate and the second substrate with at least one holding member.

4. The electro-optic assembly of claim 3, wherein the at least one holding member includes a pair of holding members spaced from one another.

5. The electro-optic assembly of claim 4, wherein the port is split by the port reduction member.

6. The electro-optic assembly of claim 3, wherein the at least one holding member includes a singular holding member that wraps around one side of the port reduction member to opposite ends of the holding member that are located on an opposite side of the port reduction member.

7. The electro-optic assembly of claim 1, wherein the port reduction member is directly adhered to one of the first substrate and the second substrate.

8. The electro-optic assembly of claim 1, wherein the port reduction member includes a semi-tubular insert defining the port.

9. An electro-optic assembly comprising:
a first substrate having a first surface and a second surface opposite the first surface;
a second substrate having a third surface and a fourth surface opposite the third surface, the first and second substrates disposed in a parallel and spaced apart relationship so as to define a cavity therebetween, the second and third surfaces facing each other;
a seal extending between the first and second substrates, an electro-optic medium located in the cavity and retained by the seal;
a port defined by the seal, the first substrate, and the second substrate; and
a port reduction member located within the port that reduces a size of the port.

10. The electro-optic assembly of claim 9, wherein the size of the port is at least partially defined by a distance between the second and third surface.

11. The electro-optic assembly of claim 10, wherein the port reduction member is located between and spaced from the second and third surface.

12. The electro-optic assembly of claim 11, wherein the port reduction member is located centrally in the distance between the second and third surface.

13. The electro-optic assembly of claim 9, wherein at least one holding member statically retains the port reduction member.

14. The electro-optic assembly of claim 13, wherein the at least one holding member includes a pair of holding members spaced from one another.

15. The electro-optic assembly of claim 13, wherein the at least one holding member is formed of epoxy.

16. The electro-optic assembly of claim 9, wherein the port reduction member is formed of glass.

17. The electro-optic assembly of claim 9, wherein the port reduction member is directly adhered to one of the first substrate and the second substrate.

18. A method of assembling an electro-optic assembly comprising steps of:
aligning a first substrate over a second substrate to define a cavity therebetween;
placing a seal between the first substrate and the second substrate to define a transmission perimeter; and
coupling a port reduction member to at least one of the first and second substrates and at least partially defining a port.

19. The method of claim 18, further comprising adhering the port reduction member directly to at least one of the first substrate or the second substrate with a holding member.

20. The method of claim 19, further comprising closing the port with at least one of closing a valve, inserting a plug, inserting and curing a medium, or deforming the port reduction member.
